(19) United States
(12) Patent Application Publication
(10) Pub. No.: US 2017/0279720 A1
(43) Pub. Date: Sep. 28, 2017

(54) Real-Time Logs

(71) Applicant: Microsoft Technology Licensing, LLC, Redmond, WA (US)

(72) Inventors: Rakesh Patnaik, Redmond, WA (US); Alaa Hassan, Redmond, WA (US); Mangalam Rathinasabapathy, Bellevue, WA (US); Baskar Narayanan, Sammamish, WA (US)

(73) Assignee: Microsoft Technology Licensing, LLC, Redmond, WA (US)

(21) Appl. No.: 15/077,881

(22) Filed: Mar. 22, 2016

(51) Int. Cl. H04L 12/801; H04L 12/851; H04L 29/06; H04L 12/24

(52) U.S. Cl. CPC H04L 47/12; H04L 41/069; H04L 47/24; H04L 63/06; H04L 63/0428; H04L 67/42

(57) ABSTRACT

In one example, a server farm may decongest traffic between a server farm and a client administrator by offloading the delivery of infrastructure logs to a log data store having a separate connection to the client. The server farm administrator may collect an infrastructure log data set for a server farm describing interactions between a client and the server farm. The server farm administrator may store the infrastructure log data set at a log data store separate from the server farm for retrieval by the client via a data store connection between the client and the log data store. The server farm may have a server farm connection between the client and the server farm separate from the data store connection to interact with the client.

### BACKGROUND

A distributed software service may allow multiple users to interact with data or an application via a data network. The data may be content on a web site or a multi-share data file, accessible to be edited by multiple users. The application may be a software as a service application that a user purchases a yearly subscription to use. The user may use a client device to interact with the distributed software service using a native application that interacts with the distributed software service or a multi-purpose application, such as a web browser, that may retrieve the data. The distributed software service may be maintained on the back end of a data connection with the client device by a set of servers, referred to as a server farm.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to decongesting traffic between a server farm and a client administrator by offloading the delivery of infrastructure logs to a log data store having a separate connection to the client. The server farm administrator may collect an infrastructure log data set for a server farm describing interactions between a client and the server farm. The server farm administrator may store the infrastructure log data set at a log data store separate from the server farm for retrieval by the client via a data store connection between the client and the log data store. The server farm may have a server farm connection between the client and the server farm separate from the data store connection to interact with the client.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a data network for a single tenant service.

FIG. 2 illustrates, in a block diagram, one example of a data network for a multiple tenant service.

FIG. 3 illustrates, in a block diagram, one example of a computing device.

FIG. 4 illustrates, in a block diagram, one example of an administrative network for a distributed software service.

FIG. 5 illustrates, in a block diagram, one example of a client site.

FIG. 6 illustrates, in a block diagram, one example of an encrypted metadata set.

FIG. 7 illustrates, in a flowchart, one example of a method for accessing a metadata set from a client site.

FIG. 8 illustrates, in a flowchart, one example of a method for accessing an infrastructure log data set from a client site.

FIG. 9 illustrates, in a block diagram, one example of a server farm.

FIG. 10 illustrates, in a flowchart, one example of a method for storing an infrastructure log data set from a server farm.

FIG. 11 illustrates, in a flowchart, one example of a method for generating a metadata set at a server farm.

FIG. 12 illustrates, in a flowchart, one example of a method for providing a metadata set from a server farm.

FIG. 13 illustrates, in a block diagram, one example of a key data store.

FIG. 14 illustrates, in a flowchart, one example of a method for storing a client-specific private key at a key data store.

FIG. 15 illustrates, in a flowchart, one example of a method for providing a client-specific private key from a key data store.

FIG. 16 illustrates, in a block diagram, one example of a log data store.

FIG. 17 illustrates, in a flowchart, one example of a method for storing an infrastructure log data set at a log data store.

FIG. 18 illustrates, in a flowchart, one example of a method for providing an infrastructure log data set from a log data store.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a server farm administration system, a computing device, or a machine-implemented method.

In one example, a server farm may decongest traffic between a server farm and a client administrator by offloading the delivery of infrastructure logs to a log data store having a separate connection to the client. The server farm administrator may collect an infrastructure log data set for a server farm describing interactions between a client and the server farm. The server farm administrator may store the infrastructure log data set at a log data store separate from the server farm for retrieval by the client via a data store connection between the client and the log data store. The server farm may have a server farm connection between the client and the server farm separate from the data store connection to interact with the client.

A service provider may provide a distributed software service to a client using a cluster of machines or servers referred to as a server farm. The clients may seek to review the infrastructure logs of these servers to analyze and monitor employee productivity, security issues, and service efficacy. These infrastructure logs may be high in volume, consuming a great deal of storage space and bandwidth when transmitted over limited network resources. Allowing clients to download the infrastructure logs through the primary servers that serve user traffic for core application functionality may severely impact performance and response times. By offloading the storage and retrieval of these infrastructure logs to a log data store, the client may access the raw infrastructure logs without affecting the performance of the server farm and without clogging the connection between the server farm and the client. The client may use a lightweight discovery application programming interface to implement a consistent authentication and authorization model to discover available infrastructure logs via the normal server farm channels. The server farm may harvest the performance data and store the resulting logs in an encrypted format to protect the infrastructure logs from access by users other than the client. The log data store may partition the resulting encrypted binary large objects, or “blobs”, based on the client or on the server farm.

The server farm may harvest a set of log performance data at regular intervals, based on either time or data size. The server farm may encrypt the log performance data set into an encrypted blob using private key encryption. In private key encryption, a secret number may be used to encrypt a set of data, making the set of data unusable until decrypted by the same secret number. Each encrypted blob has a private key specific to that encrypted blob. The server farm may then store the encrypted blob in the log data store.

The server farm may generate a metadata set describing the log performance data set for each encrypted blob. The metadata set may describe the location of the encrypted blob within the log data store. Additionally, the metadata set may store the private key used to encrypt the encrypted blob. The server farm may then encrypt the metadata set using a second private key that is specific to the client, so that just that client may view the decrypted metadata set. The server farm may then store the encrypted metadata set at the log data store or locally at the server farm. The server farm may store the client-specific private key in a local data storage. Alternately, for purposes of scalability, the server farm may encrypt the client-specific private key using a server-specific private key and store the encrypted client-specific private key at a key data store.

Upon request by the client, the server farm may retrieve the encrypted metadata set describing the infrastructure log data set from the log data store. The server farm may retrieve the encrypted client-specific private key from the key data store. The server farm may decrypt the encrypted client-specific private key using the server-specific private key. The server farm may then decrypt the encrypted metadata set using the client-specific private key. The server farm may then provide the decrypted metadata set to the client via secure server farm connection between the server farm and the client. The client may then use the location data in the metadata set to request the encrypted blob from the log data store. The log data store may provide the encrypted blob over a different channel to the client without impacting the traffic between the client and the server farm. The client may use the blob-specific private key from the metadata set to decrypt the infrastructure log data set.

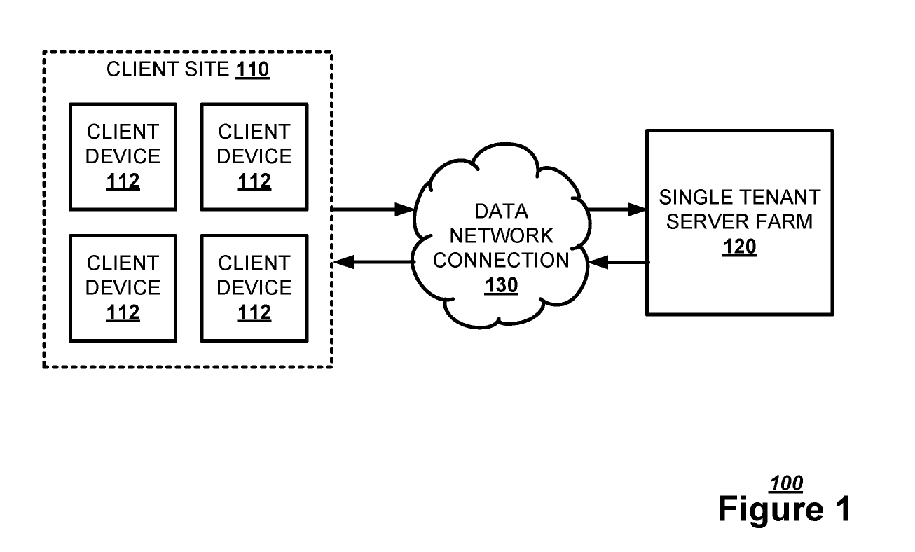

The server farm administration system may monitor a server farm serving a single tenant or multiple tenants. FIG. 1 illustrates, in a block diagram, one example of a data network 100 for a single tenant service. A client site 110 may have one or more client devices 112 that connect to a single tenant server farm 120 via a data network connection 130. The data network connection 130 may be an internet connection, a wide area network connection, a local area network connection, or other type of data network connections. The single tenant server farm 120 may have one or more servers dedicated to executing one or more distributed software services for the single client site 110. Each client device 112 may execute a distributed software service client to access the one or more distributed software services or data maintained by the single tenant server farm 120. The distributed software service client may be a separate application or integrated into an operating system or an internet browser platform. The single tenant server farm 120 may guarantee a set amount of resources to a client site 110. Further, the single tenant server farm 120 may more accurately track usage by the client site 110 to tailor the resources to the client site 110.

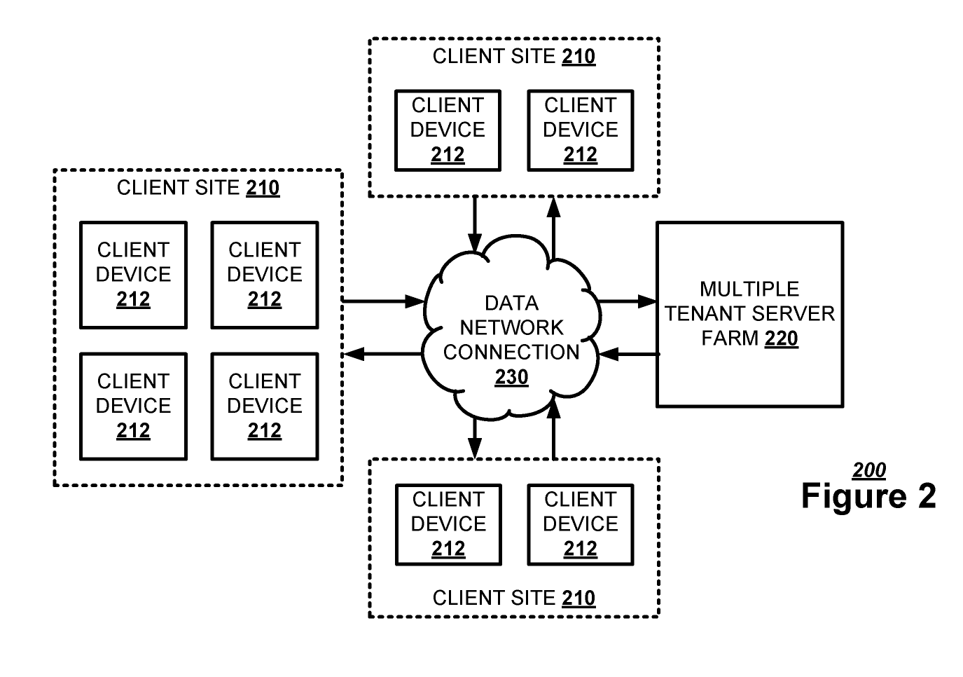

FIG. 2 illustrates, in a block diagram, one example of a data network 200 for a multiple tenant service. Multiple client sites 210 may share a multiple tenant server farm 220 via a data network connection 230. Each client site 210 may have one or more client devices 212. The multiple tenant server farm 220 may have one or more servers allocating one or more distributed software services for each client site 210 based on client site usage. Each client device 212 may execute a distributed software service client to access the one or more distributed software services or data maintained by the multiple tenant server farm. The multiple tenant server farm 220 may efficiently and cheaply provide resources to the client sites 210 by redistributing resources from idle client sites 210 to active client sites 210. Thus, multiple tenant server farms 220 may tend to be more common than single tenant server farms.

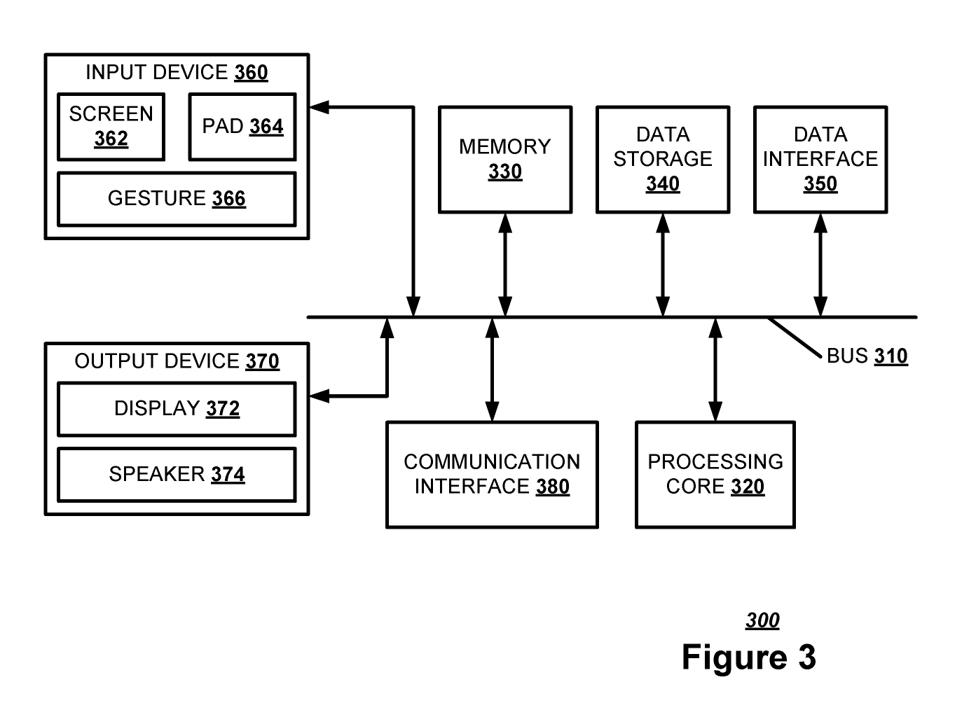

FIG. 3 illustrates a block diagram of an exemplary computing device 300 which may act as a server farm administration system. The computing device 300 may combine one or more of hardware, software, firmware, and system-on-a-chip technology to implement a server farm administration system. The computing device 300 may include a bus 310, a processing core 320, a memory 330, a data storage 340, a data interface 350, an input device 360, an output device 370, and a communication interface 380. The bus 310, or other component interconnection, may permit communication among the components of the computing device 300.

The processing core 320 may include at least one conventional processor or microprocessor that interprets and executes a set of instructions. The processing core 320 may be configured to execute a data loader to collect an infrastructure log data set for a server farm describing interactions between a client and the server farm. The processing core 320 may be further configured to encrypt an infrastructure log data set using a blob-specific private key. The processing core 320 may be also configured to generate a metadata set describing the infrastructure log data set. The metadata set may identify at least one of a server generating the infrastructure log data set, a log type describing a log format for the infrastructure log data set, an infrastructure log data set location in the log data store, and an expiration date describing a time period the log data store keeps the infrastructure log data set. The processing core 320 may be additionally configured to encrypt a metadata set describing the infrastructure log data set using a client-specific private key. The processing core 320 may be also configured to encrypt a client-specific private key for the client using a server-specific private key for storage in a separate key data store. The processing core 320 may be further configured to decrypt an encrypted metadata set using a client-specific private key prior to create a decrypted metadata set describing the infrastructure log data set for the client.

The memory 330 may be a random access memory (RAM) or another type of dynamic data storage that stores information and instructions for execution by the processing core 320. The memory 330 may also store temporary variables or other intermediate information used during execution of instructions by the processing core 320. The memory 330 may be configured to store a blob-specific private key in a metadata set describing the infrastructure log data set.

The data storage 340 may include a conventional ROM device or another type of static data storage that stores static information and instructions for the processing core 320. The data storage 340 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 340 may store a set of instructions detailing a method that when executed by one or more processors cause the one or more processors to perform the method.

Additionally, a data interface 350 may access a data store or a database. The data interface 350 may be configured to store an infrastructure log data set at a log data store separate from the server farm for retrieval by the client via a data store connection between the client and the log data store. The data interface 350 may be further configured to store a metadata set describing the infrastructure log data set in the log data store.

The input device 360 may include one or more conventional mechanisms that permit a user to input information to the computing device 300, such as a keyboard, a mouse, a voice recognition device, a microphone, a headset, a touch screen 362, a touch pad 364, a gesture recognition device 366, etc. The output device 370 may include one or more conventional mechanisms that output information to the user, including a display screen 372, a printer, one or more speakers 374, a headset, a vibrator, or a medium, such as a memory, or a magnetic or optical disk and a corresponding disk drive.

The communication interface 380 may include any transceiver-like mechanism that enables computing device 300 to communicate with other devices or networks. The communication interface 380 may include a network interface or a transceiver interface. The communication interface 380 may be a wireless, wired, or optical interface. The communication interface 380 may be configured to execute the interactions between the client and the server farm via a server farm connection between the client and the server farm separate from the data store connection of the log data store. The client may be a sole tenant of the server farm. The server farm connection may be a secure server farm connection, with security protocols in place to prevent the interception of data transmissions between the server farm and the client. The communication interface 380 may be further configured to receive a request for a metadata set describing the infrastructure log data set from the client via an application programming interface. The communication interface 380 may be additionally configured to send the metadata set describing the infrastructure log data set to the client.

The computing device 300 may perform such functions in response to processing core 320 executing sequences of instructions contained in a computer-readable medium, such as, for example, the memory 330, a magnetic disk, or an optical disk. Such instructions may be read into the memory 330 from another computer-readable medium, such as the data storage 340, or from a separate device via the communication interface 370.

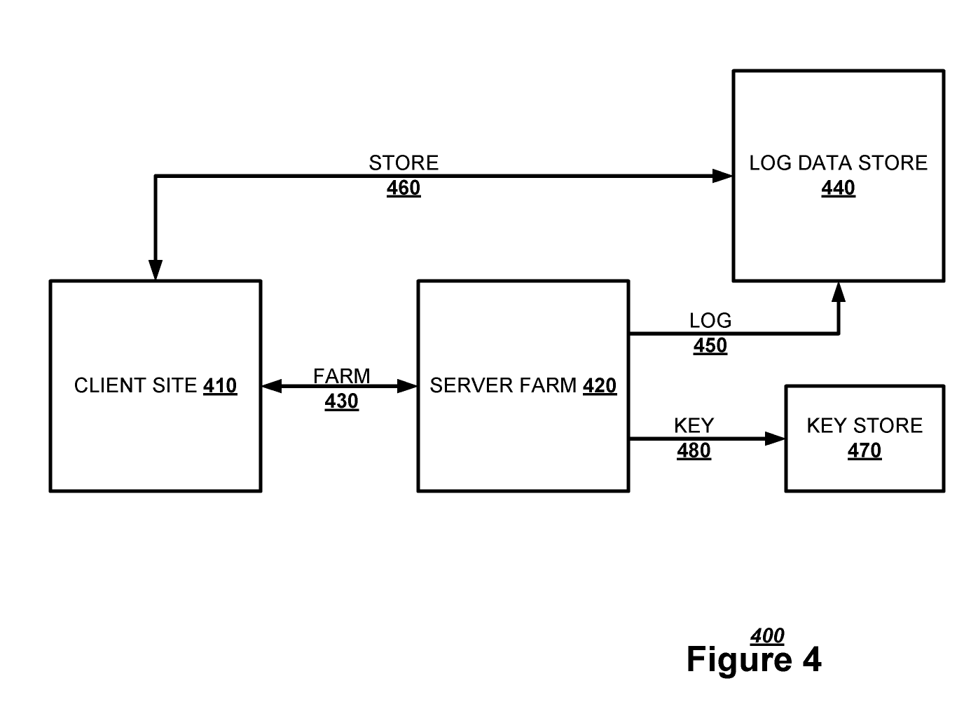

FIG. 4 illustrates, in a block diagram, one example of an administrative network 400 for a distributed software service. A client site 410 may have one or more client devices that connect to a server farm 420 via a server farm connection 430. The server farm connection 430 may be a secure data network connection for transferring data between the client site 410 and the server farm 420. The server farm 420 may have one or more servers dedicated to executing one or more distributed software services for the client site 410.

The server farm 420 may maintain an infrastructure log data set for the server farm 420 describing interactions between a client and the server farm 420. For example, the infrastructure log data set may describe what data and services were accessed by which users at which times, as well as any faults or errors that occurred during those interactions. The server farm 420 may offload storage of the infrastructure log data set to a log data store 440 via a log data connection 450. The client site 410 may access the infrastructure log data set on the log data store 440 via a data store connection 460. The data store connection 460 may be separate from the server farm connection 430. By having the data store connection 460 separate from the server farm connection 430, the server farm connection 430 may be unimpeded in the performance of normal communications between client site 410 and the server farm 420.

To make sure that just the client has access to the data stored in the log data store 440, the server farm 420 may use a client-specific private key to encrypt the data. Specifically, the server farm 420 may use a blob-specific private key to encrypt the infrastructure log data set as an encrypted blob for storage at the log data store 440. The server farm 420 may then generate a metadata set describing the infrastructure log data set having the blob-specific private key. The server farm 420 may then encrypt the metadata set with the client-specific private key for storage at the log data store 440. For scalability purposes, the server farm 420 may encrypt the client-specific private key with a server-specific private key for storage in a separate key data store 470 via a key data connection 480.

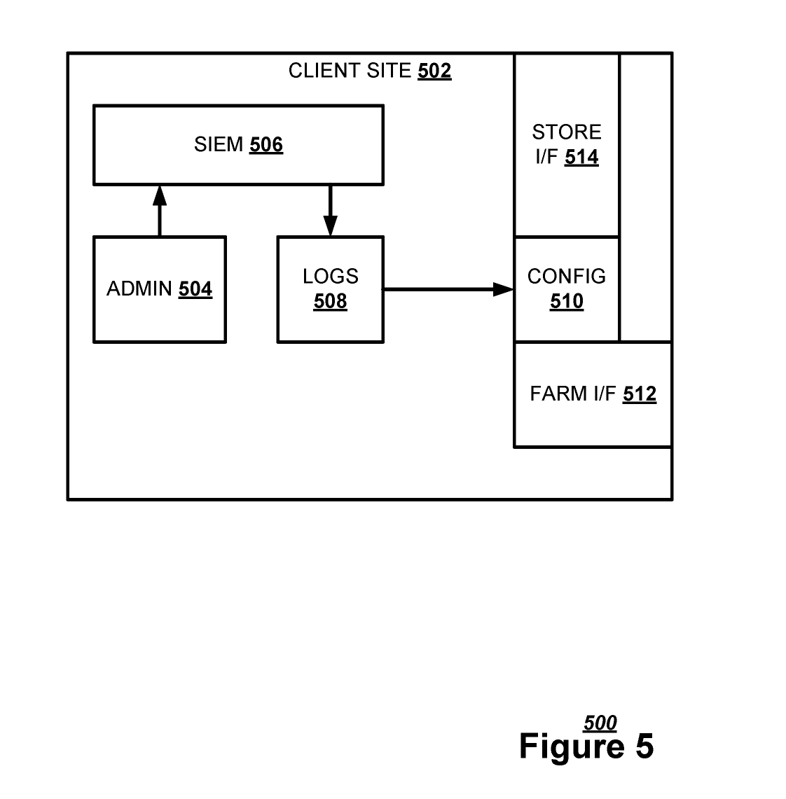

FIG. 5 illustrates, in a block diagram, one example of a client site administrator 500. For a client site 502, the client site administrator 500 may execute an administration application module 504 to monitor the interactions of the client site 502 with a server farm. The administration application module 504 may use security information and event management (SIEM) tool 506 to access a set of raw infrastructure log data 508. The security information and event management tool 506 may execute a configuration framework application 510 to call an application programming interface (API) at the server farm to access a metadata set describing the infrastructure log data set. The server farm may associate the metadata set with the client site by encrypting the metadata set with a private key associated with the client site. The configuration framework 510 may pass on a configured credential to the application programming interface to access the metadata set. The configuration framework 510 may retrieve the metadata set from the server farm via a server farm connection interface (I/F) 512. The configuration framework 510 may use the metadata set to determine the location of the raw infrastructure log data 508. The configuration framework 510 may retrieve an encrypted blob from the log data store via a data store interface 514. The configuration framework 510 may decrypt the encrypted blob to produce the raw infrastructure log data 508 using a blob-specific private key contained in the metadata set.

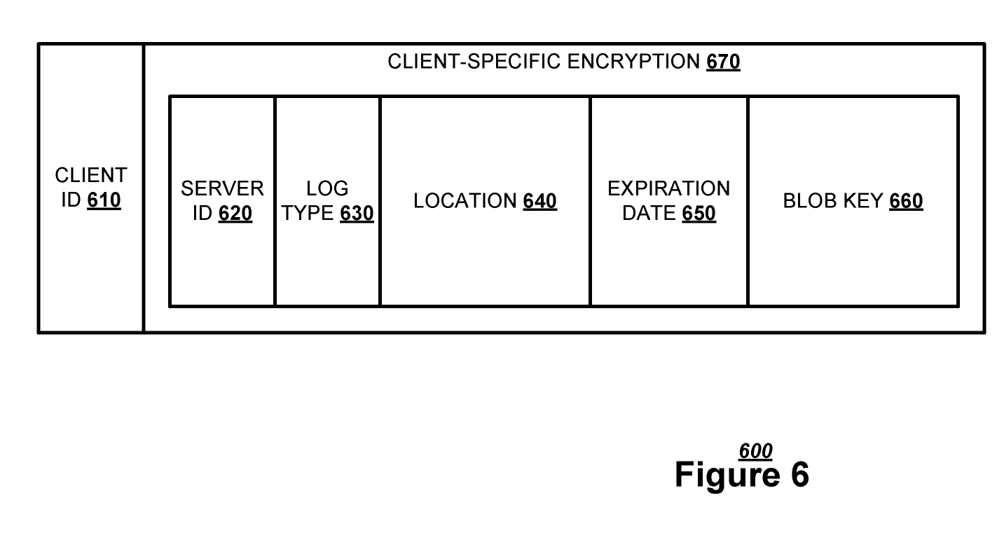

FIG. 6 illustrates, in a block diagram, one example of an encrypted metadata set 600. The encrypted metadata set 600 may have a client identifier 610 identifying the client whose interactions the infrastructure log data set describes. The encrypted metadata set may have a server identifier 620 indicating the server generating the infrastructure log data set. The encrypted metadata set 600 may have a log type 630 describing the format for the infrastructure log data set. The encrypted metadata set 600 may have an infrastructure log data set location 640 identifying the data location where the infrastructure log data set is stored in the log data store, such as a uniform resource identifier (URI). The encrypted metadata set 600 may have an expiration date 650 describing a time period the log data store keeps the infrastructure log data set The encrypted metadata set 600 may store a blob-specific private key 660 used to encrypt the infrastructure log data set. The encrypted metadata set 600 may have a client-specific encryption 670 applied using a client-specific private key. Thus, just the client associated with the client-specific private key may access the metadata set. Once the server farm has decrypted the encrypted metadata set 600 and provided the decrypted metadata set to the client, the client may use the infrastructure log data set location 640 to retrieve a binary large object, or blob, from the log data store. The client may then use the blob-specific private key 660 in the metadata set to decrypt the blob to access the infrastructure log data set.

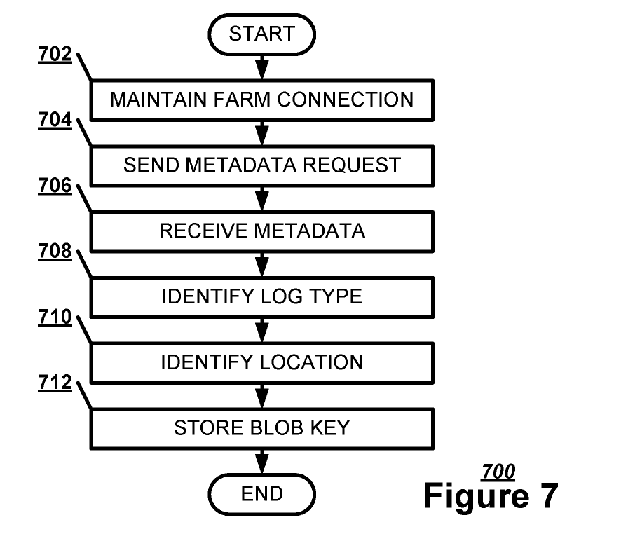

FIG. 7 illustrates, in a flowchart, one example of a method 700 for accessing a metadata set with a client. The client may maintain a secure server farm connection between a client and a server farm (Block 702). The security information and event management tool of the client may send a metadata access request on the secure server farm connection for an encrypted metadata set describing an infrastructure log data set describing interactions between the client and the server farm (Block 704). The security information and event management tool may receive a metadata set from the server farm via the secure server farm connection (Block 706). The security information and event management tool may identify a log type for the infrastructure log data set in the metadata set (Block 708). The security information and event management tool may identify an infrastructure log data set location for the infrastructure log data set in the metadata set (Block 710). The security information and event management tool may store a blob-specific private key used to encrypt the infrastructure log data set in the metadata set (Block 712).

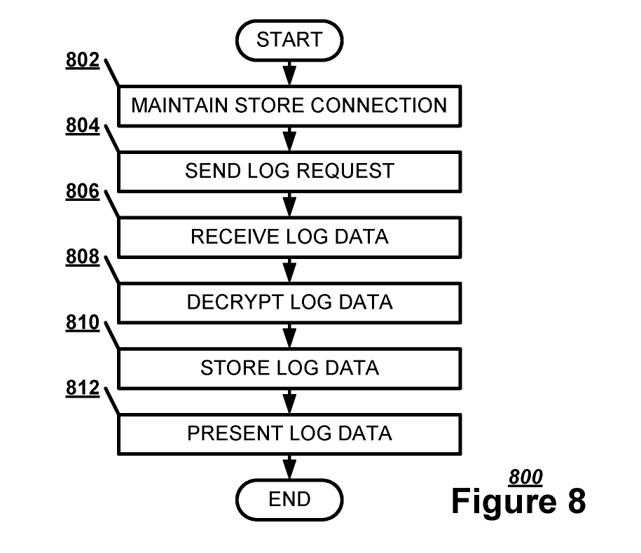

FIG. 8 illustrates, in a flowchart, one example of a method 800 for accessing an infrastructure log data set with a client. The client may maintain a data store connection between a client and a log data store to receive the infrastructure log data set (Block 802). The security information and event management tool may send a log request for the infrastructure log data set based on the metadata set describing the infrastructure log data set on the data store connection (Block 804). The security information and event management tool may receive an encrypted infrastructure log data set from the log data store via the data store connection (Block 806). The security information and event management tool may use the blob-specific private key to decrypt the encrypted infrastructure log data set (Block 808). The security information and event management tool may store the infrastructure log data set in a secure data location (Block 810). The security information and event management tool may present the infrastructure log data set to an administrator (Block 812).

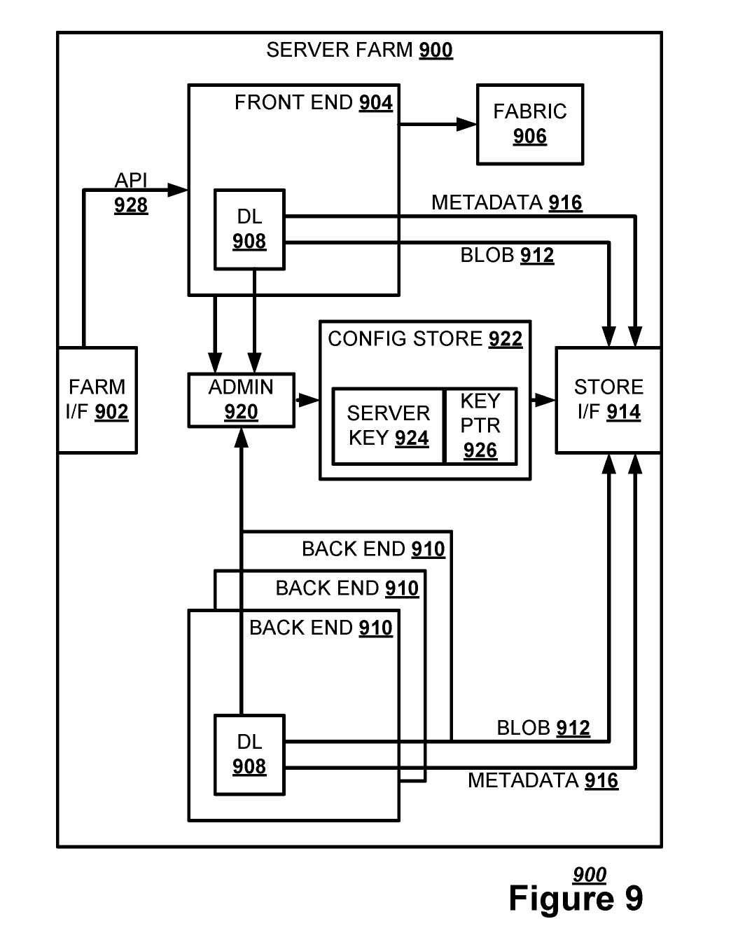

FIG. 9 illustrates, in a block diagram, one example of a server farm 900. The server farm 900 may connect with a client site via a secure server farm connection. A server farm interface (I/F) 902 may receive a data interaction from the secure server farm connection. A front end application 904 may provide access to a set of distributed software service features stored on a service fabric 906.

The server farm 900 may use a data loader 908 to collect an infrastructure log data set describing the client interactions with the stored distributed software service features. The data loader 908 may also collect further infrastructure log data from any back end applications 910 supporting the front end application 904. In a single tenant server farm, the infrastructure log data at the server farm is directed to the single client that is using the server farm. In a multiple tenant server farm, where the infrastructure log data may be directed to multiple tenants, the data loader 908 may filter the infrastructure log data to contain just the performance data for a single tenant. The data loader 908 may use a blob-specific private key to encrypt a chunk of infrastructure log data into an encrypted blob 912 to be sent to a log data store via a data store interface 914.

The data loader 908 may track the server generating the infrastructure log data, the log type for the infrastructure log data in the blob 912, the location in the log data store containing the blob 912, the expiration date describing the time period the log data store keeps the blob 912, and the blob-specific private key used to encrypt the blob 912. The data loader 908 may generate a metadata set 916 describing these features of the infrastructure log data set. The data loader 908 may use a client-specific private key to encrypt the metadata prior to storage in the log data store. The data loader 908 may send the encrypted metadata set 916 to the log data store via the log data store interface 920 for storage.

The data loader 908 may use a server administration module 920 to manage the client-specific private key used to encrypt the metadata. The server administration module 920 may store the client-specific private key in a configuration store 922 at the server farm 900. Alternately, the server administration module 920 may encrypt the client-specific private key using a private key specific to the server generating the infrastructure log data. The server administration module 920 may access a key data connection via the data store interface 914 to send the encrypted client-specific private key to a key data store for storage. The server administration module 920 may store in the configuration storage 922 the server-specific private key 924 with a key pointer 926 identifying the location of the encrypted client-specific private key in the key data store.

The security information and event management tool at the client may use an application programming interface 928 at the server farm to request the metadata set 922 via the front end application 904. The server administration module 920 may retrieve the encrypted client-specific private key from the key data store via the data store interface 914. The server administration module 920 may decrypt the encrypted client-specific private key using the server-specific private key. The server administration module 920 may retrieve the encrypted metadata set 916 from the log data store via the data store interface 914. The server administration module 920 may decrypt the encrypted metadata set 916 using the client-specific private key. The server administration module 920 may use the server farm interface 902 to send the metadata set 916 to the client site administrator via the secure server farm connection.

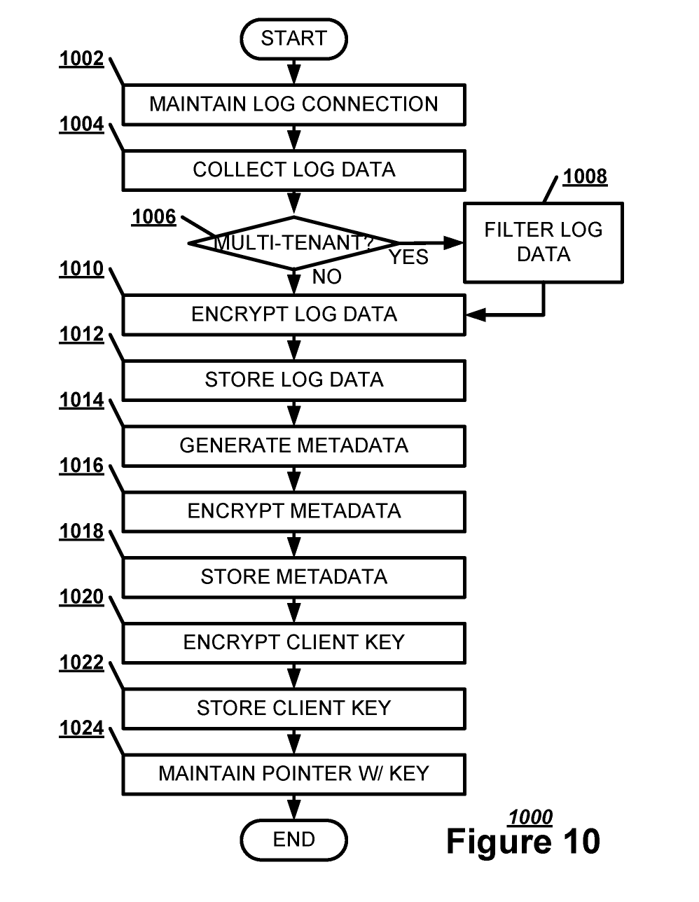

FIG. 10 illustrates, in a flowchart, one example of a method 1000 for storing an infrastructure log data set from a server farm. The server farm may maintain a log data connection between the server farm and a log data store (Block 1002). A data loader at the server farm may collect an infrastructure log data set describing interactions between a client and the server farm via a server farm connection (Block 1004). If the server farm is a multiple tenant server farm (Block 1006), the data loader may filter performance data unrelated to a tenant from the infrastructure log data set (Block 1008). The data loader may encrypt the infrastructure log data set using a blob-specific private key prior to storage at a log data store (Block 1010). The data loader may store the infrastructure log data set in a log data store for retrieval via a data store connection between the client and the log data store separate from the server farm connection (Block 1012). The data loader may generate a metadata set describing the infrastructure log data set (Block 1014). The data loader may encrypt the metadata set using a client-specific private key for a client to create an encrypted metadata set (Block 1016). The data loader may store the encrypted metadata set in the log data store used to store the infrastructure log data set (Block 1018). A server administration module at the server farm may encrypt the client-specific private key using a server-specific private key to create an encrypted client-specific private key (Block 1020). The server administration module may store the encrypted client-specific private key in a key data store separate from the log data store (Block 1022). The server administration module may maintain the server-specific private key with a key pointer identifying the location of the encrypted client-specific private key in the key data store (Block 1024).

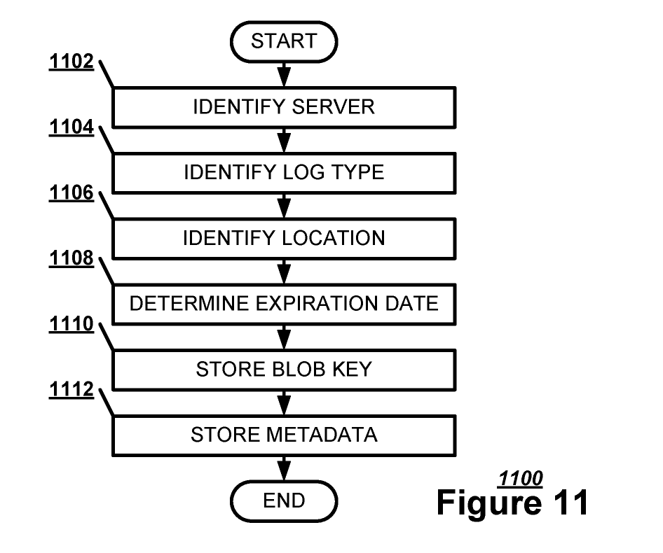

FIG. 11 illustrates, in a flowchart, one example of a method 1100 for generating a metadata set at a server farm. The data loader may identify a server generating the infrastructure log data (Block 1102). The data loader may identify a log type describing a file format for the infrastructure log data set in the encrypted metadata set (Block 1104). The data loader may identify an infrastructure log data set location at the log data store in the encrypted metadata set (Block 1106). The data loader may determine an expiration date for the infrastructure log data based upon time and date of storage and the log data store retention policies (Block 1108). The data loader may store a blob-specific private key used to encrypt the infrastructure log data set in the metadata set prior to encryption (Block 1110). The data loader may store the encrypted metadata set describing the log type, the infrastructure log data set location, and the blob-specific private key (Block 1112).

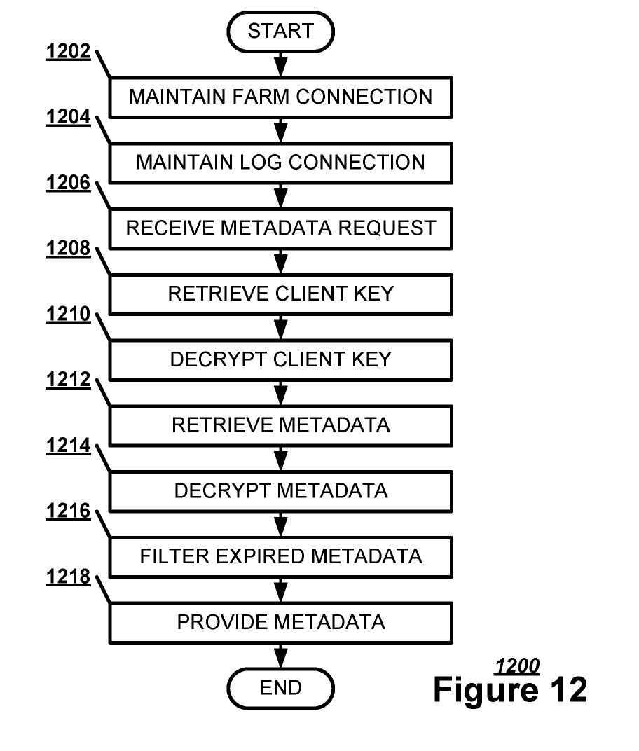

FIG. 12 illustrates, in a flowchart, one example of a method 1200 for providing a metadata set from a server farm. The server farm may maintain a secure server farm connection between a client and a server farm (Block 1202). The server farm may maintain a log data connection between the server farm and a log data store (Block 1204). A server administration module at the server farm may receive a metadata access request from the client for the metadata set via an application programming interface that has been properly authenticated and authorized (Block 1206). The server administration module may retrieve the encrypted client-specific private key from a key data store (Block 1208). The server administration module may decrypt the encrypted client-specific private key using a server-specific private key (Block 1210). The server administration module may retrieve the encrypted metadata set in the log data store via the log data connection (Block 1212). The server administration module may decrypt the encrypted metadata set using the client-specific private key using a server-specific private key to create a decrypted metadata set (Block 1214). The server administration may filter any decrypted metadata set that has passed an expiration date listed in the metadata set (Block 1216). The server administration may provide the decrypted metadata set via the secure server farm connection to the client to facilitate access to the infrastructure log data set (Block 1218).

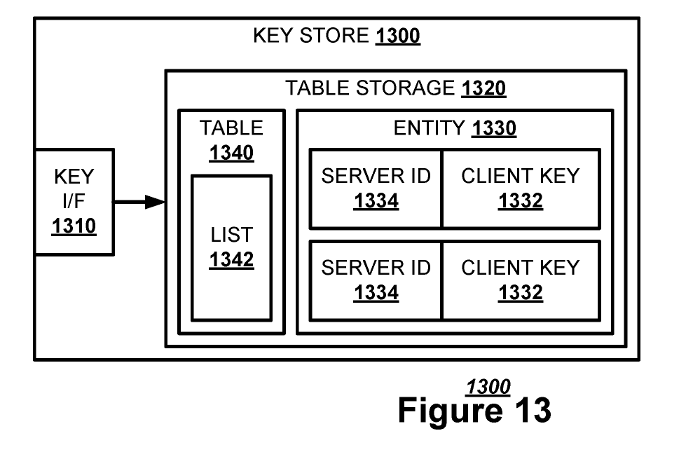

FIG. 13 illustrates, in a block diagram, one example of a key data store 1300. The key data store 1300 may connect to a server farm via a key data interface 1310. The server farm may store in table storage 1320 as an entity 1330 a client-specific private key 1332 use to encrypt an encrypted metadata set 1632 stored at a separate log data store. The server farm may encrypt the client specific private key 1332 with a server-specific private key prior to encryption. The server farm may keep the server-specific private key stored locally. The table storage 1320 may organize the entity 1330 to associate the encrypted client-specific private key 1332 with a server identifier 1334 indicating the server that holds the server-specific private key. The table storage 1630 may use a table format 1340 to organize a list 1342 of the one or more stored entities 1320. The server farm may use the list 1342 and a server pointer maintained at the server farm to locate the encrypted client-specific private key

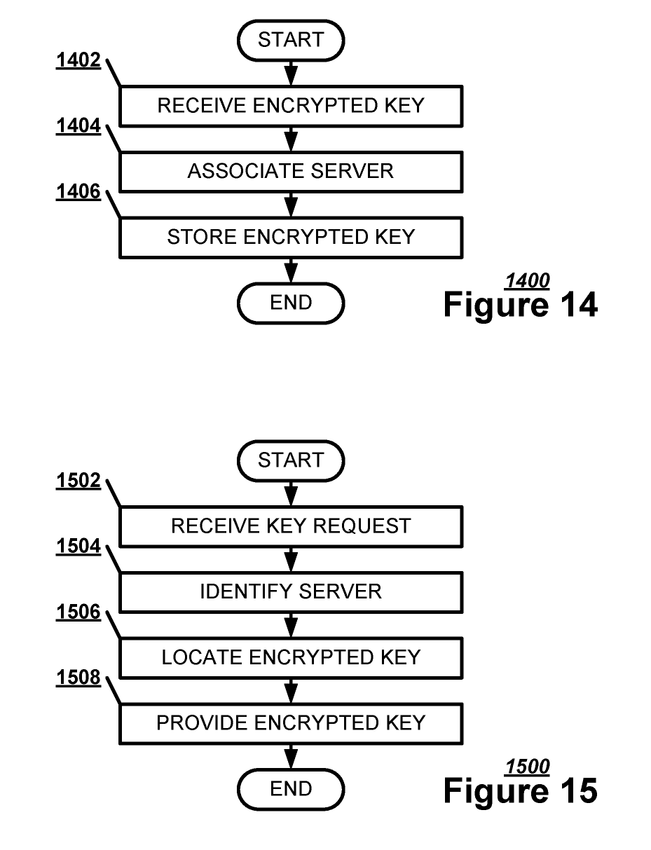

FIG. 14 illustrates, in a flowchart, one example of a method 1400 for storing a client-specific private key at a key data store. The key data store may receive the encrypted client-specific private key from the server farm (Block 1402). The key data store may associate the encrypted client-specific private key with a server identifier identifying the server of the server farm providing the encrypted client-specific private key (Block 1404). The key data store may store the encrypted client-specific private key with the server identifier in a table storage (Block 1406).

FIG. 15 illustrates, in a flowchart, one example of a method 1500 for providing a client-specific private key from a log data store. The key data store may receive a key request from the server farm (Block 1502). The key data store may identify the server of the server farm requesting the encrypted client-specific private key (Block 1504). The key data store may locate the encrypted client-specific private key based upon the requesting server (Block 1506). The key data store may provide the encrypted client-specific private key to the server farm (Block 1508).

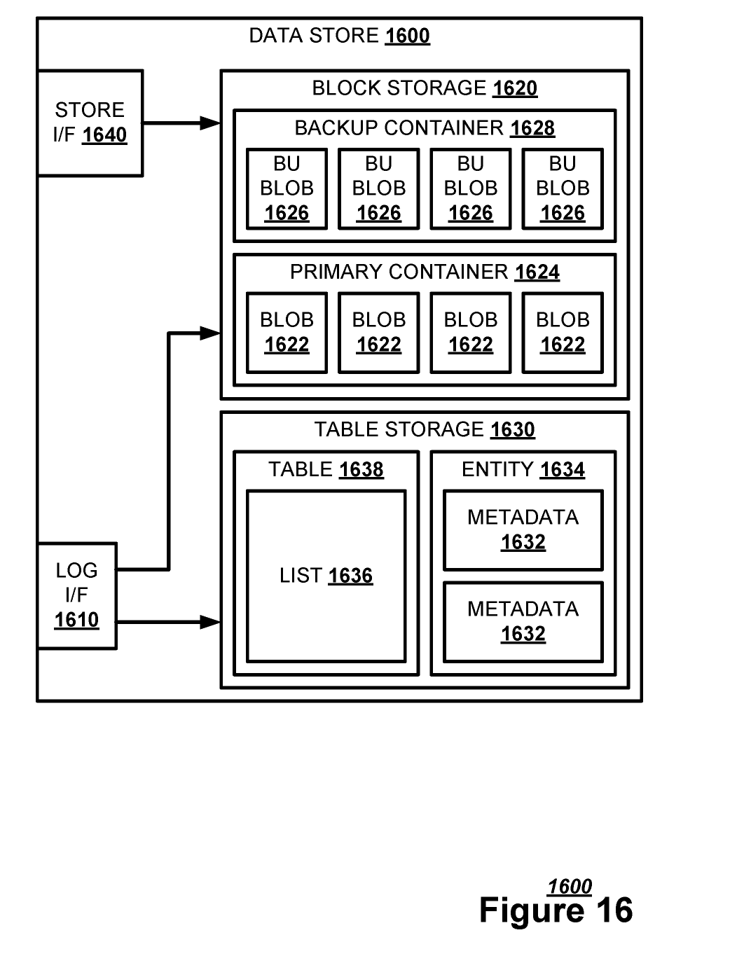

FIG. 16 illustrates, in a block diagram, one example of a log data store 1600. The log data store may be separate from a server farm. The log data store 1600 may connect to a server farm via a log data interface 1610. The server farm may store one or more blobs 1622 of encrypted infrastructure log data in block storage 1620 in the log data store 1600. The block storage 1620 may partition the blobs 1622 based on the server farm or, in the case of multiple tenant server farms, based on the client. The block storage 6120 may store the blobs 1622 in a primary container 1624. The log data store 1600 may create a backup (BU) blob 1626 in a backup container 1628 for each blob 1622 in a primary container 1624.

The server farm may store in table storage 1630 an encrypted metadata set 1632 describing the blobs 1622. The server farm may use a client-specific private key to encrypt the encrypted metadata set 1632, associating the metadata set 1632 with the client. The table storage 1630 may organize the encrypted metadata set 1632 as an entity 1634 containing a specific set of properties, such as log type, infrastructure log data set location, and blob-specific private key. The table storage 1630 may maintain a list 1636 of one or more stored encrypted metadata sets 1632. The table storage 1630 may organize the list 1636 in a table format 1638.

To access a specific infrastructure log data set, the server farm may look up the location of an encrypted metadata set 1632 for a specific client in the list 1636 and retrieve the encrypted metadata set 1632. The server farm may decrypt the encrypted metadata set 1632 using the client-specific private key for presentation to the client. The client may use the metadata set 1632 to identify the data location in the data container 1624 of the encrypted blob 1622. The client may then retrieve the encrypted blob 1622 in block storage 1620 over the data store connection via the data store connection interface 1640. The log data store 1600 may receive in the data store connection interface 1640 a log request for the infrastructure log data set. The log request may present a uniform resource identifier indicating the location of the blob, as well as a shared access signature token authenticating the client.

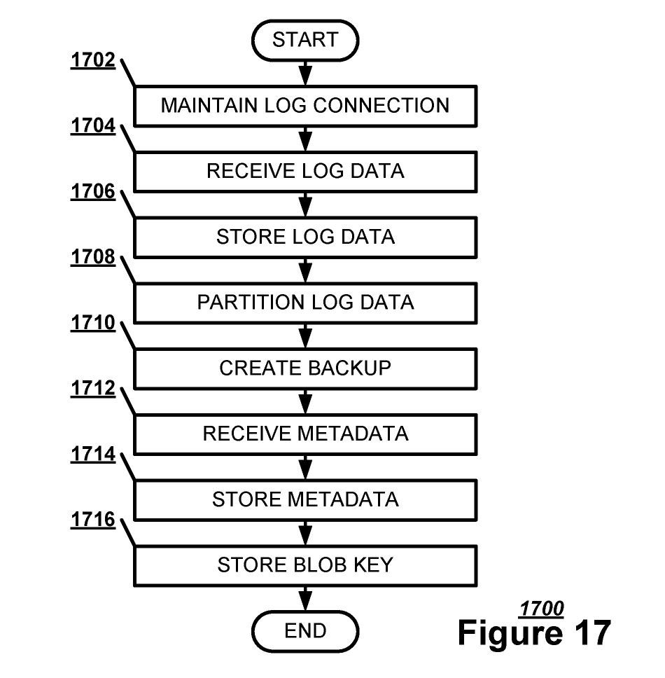

FIG. 17 illustrates, in a flowchart, one example of a method 1700 for storing an infrastructure log data set at a log data store. The log data store may maintain a log data connection between the log data store and a server farm (Block 1702). The log data store may receive an infrastructure log data set for a server farm describing interactions between a client and the server farm (Block 1704). The log data store may store the infrastructure log data set that has been encrypted at the server farm using a blob-specific private key (Block 1706). The log data store may partition storage of the infrastructure log data set based on the client or the server farm (Block 1708). The log data store may create a backup log data set of the infrastructure log data set for storage in a backup container (Block 1710). The log data store may receive a metadata set describing the infrastructure log data set with the metadata set encrypted at the server farm by a client-specific private key (Block 1712). The log data store may store the metadata set in a table storage (Block 1714). The log data store may store a blob-specific private key for encrypting the infrastructure log data set in the metadata set (Block 1716).

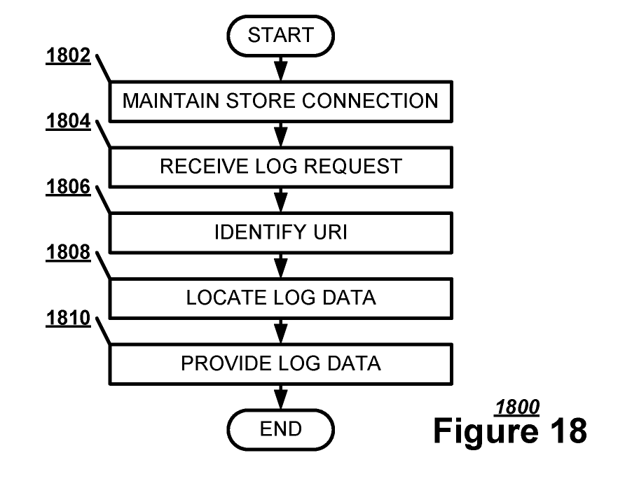

FIG. 18 illustrates, in a flowchart, one example of a method 1800 for providing an infrastructure log data set from a log data store. The log data store may maintain an data store connection between the log data store and a client to send the infrastructure log data set (Block 1802). The log data store may receive from the client a log request for an infrastructure log data set based on a metadata set describing the infrastructure log data set (Block 1804). The log data store may identify a uniform resource identifier in the log request (Block 1806). The log data store may locate the infrastructure log data set based on the uniform resource identifier (Block 1808). The log data store may provide the infrastructure log data set to the client via a data store connection between the client and the log data store separate from a server farm connection between the client and the server farm (Block 1810).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A server farm administration system, comprising:
a processing core having at least one processor configured to collect an infrastructure log data set for a server farm describing interactions between a client and the server farm;
a data interface configured to store the infrastructure log data set at a log data store separate from the server farm for retrieval by the client via a data store connection between the client and the log data store; and
a communication interface configured to execute interactions between the client and the server farm via a server farm connection between the client and the server farm separate from the data store connection.

2. The server farm administration system of claim 1, wherein the processing core is further configured to encrypt the infrastructure log data set using a blob-specific private key.

3. The server farm administration system of claim 1, wherein the processing core is further configured to generate a metadata set describing the infrastructure log data set.

4. The server farm administration system of claim 3, wherein the metadata set identifies at least one of a server generating the infrastructure log data set, a log type describing a log format for the infrastructure log data set, an infrastructure log data set location in the log data store, and an expiration date describing a time period the log data store keeps the infrastructure log data set.

5. The server farm administration system of claim 1, further comprising:
memory configured to store a blob-specific private key in a metadata set describing the infrastructure log data set.

6. The server farm administration system of claim 1, wherein the processing core is further configured to encrypt a metadata set describing the infrastructure log data set using a client-specific private key.

7. The server farm administration system of claim 1, wherein the processing core is further configured to encrypt a client-specific private key for the client using a server-specific private key for storage in a separate key data store.

8. The server farm administration system of claim 1, wherein the data interface is configured to store a metadata set describing the infrastructure log data set in the log data store.

9. The server farm administration system of claim 1, wherein the communication interface is configured to receive a request for a metadata set describing the infrastructure log data set from the client via an application programming interface.

10. The server farm administration system of claim 1, wherein the processing core is further configured to decrypt an encrypted metadata set using a client-specific private key prior to create a decrypted metadata set describing the infrastructure log data set for the client.

11. The server farm administration system of claim 1, wherein the communication interface is configured to send a metadata set describing the infrastructure log data set to the client.

12. The server farm administration system of claim 1, wherein the client is a sole tenant of the server farm.

13. A computing device, having a memory to store a series of instructions to manage a log data store, the computing device configured to
receive an infrastructure log data set for a server farm describing interactions between a client and the server farm in the log data store;
receive from the client a log request for an infrastructure log data set based on a metadata set describing the infrastructure log data set; and
provide the infrastructure log data set to the client via a data store connection between the client and the log data store separate from a server farm connection between the client and the server farm.

14. The computing device of claim 13, wherein the computing device is further configured to
partition storage of the infrastructure log data set at the log data store based on the client.

15. The computing device of claim 13, wherein the computing device is further configured to
create a backup log data set of the infrastructure data log set for storage in a backup container.

16. The computing device of claim 13, wherein the computing device is further configured to
store the infrastructure log data set that has been encrypted at the server farm using a blob-specific private key.

17. The computing device of claim 13, wherein the computing device is further configured to
store a blob-specific private key for encrypting the infrastructure log data set in the metadata set at the log data store.

18. The computing device of claim 13, wherein the computing device is further configured to
identify a uniform resource identifier in the log request.

19. A machine-implemented method, comprising:
collecting at a server farm an infrastructure log data set describing interactions between a client and the server farm via a server farm connection;
generating a metadata set describing the infrastructure log data set;
encrypting the metadata set using a client-specific private key for a client to create an encrypted metadata set;
receiving a metadata access request from the client for the metadata set;
decrypting the encrypted metadata set using the client-specific private key to create a decrypted metadata set; and
providing the decrypted metadata set to the client to facilitate access to the infrastructure log data set.

20. The method of claim 19, further comprising:
storing the infrastructure log data set in a log data store for retrieval via a data store connection between the client and the log data store separate from the server farm connection.
